(19) United States
(12) Patent Application Publication
(10) Pub. No.: US 2022/0297721 A1
(43) Pub. Date: Sep. 22, 2022

(54) MULTI-SENSOR SYNCHRONIZATION METHOD AND SYSTEM

(71) Applicant: SHENZHEN ANTU AUTONOMOUS DRIVING TECHNOLOGIES LTD., Shenzhen (CN)

(72) Inventor: Jianxiong XIAO, Shenzhen (CN)

(21) Appl. No.: 17/694,712

(22) Filed: Mar. 15, 2022

(30) Foreign Application Priority Data
Mar. 16, 2021 (CN) 2021102785463

(51) Int. Cl. B60W 60/00; B60W 50/12; B60W 50/10

(52) U.S. Cl. CPC B60W 60/001; B60W 50/12; B60W 50/10; B60W 2420/42; B60W 2420/52

(57) ABSTRACT

A multi-sensor synchronization method is provided. The method comprises steps of: obtaining a first field of viewing direction of a first sensor, and a second field of viewing direction of a second sensor, the second sensor being rotatable; calculating a synchronization time when the second sensor is rotated to change the second field of viewing direction to be consistent with the first field of viewing direction; when the time of the current moment is earlier than the synchronization time by a preset time, triggering the first sensor to output a first image; adjusting first sensing parameters of the first sensor to obtain second sensing parameters according to the first image; and when the second sensor is rotated to change the second field of viewing direction to be consistent with the first field of viewing direction, triggering the first sensor to output a second image based on the second sensing parameters.

### CROSS REFERENCE TO RELATED APPLICATION

This non-provisional patent application claims priority under 35 U.S.C. § 119 from Chinese Patent Application No. 202110278546.3 filed on Mar. 16, 2021, the entire content of which is incorporated herein by reference.

### TECHNICAL FIELD

The disclosure relates to the field of autonomous driving technology, and in particular to a multi-sensor synchronization method and a system thereof.

### BACKGROUND

Autonomous driving vehicles detecting obstacles during driving is one key technology for environmental perception. The autonomous driving vehicles is equipped with sensors to collect environmental data around the autonomous driving vehicles in real time during driving. The sensors transmit the environmental data to a control system of the autonomous driving vehicles. The control system analyzes the environmental data to control the autonomous driving vehicle.

Cameras and lidars are the two most commonly sensors today. However, when the autonomous driving vehicles is driven only based on environmental data collected by the cameras or the lidars in an unknown and complex environment, it needs a variety of sensors to collect environmental data to ensure safety of the autonomous driving vehicles.

Therefore, synchronization between a plurality of sensors is an urgent problem to be solved.

### SUMMARY

The disclosure provides a multi-sensor synchronization method and a system thereof, the method effectively solves synchronization problem between a plurality of sensors.

A first aspect of the disclosure provides a multi-sensor synchronization method, and the multi-sensor synchronization method includes the steps of: obtaining a first field of viewing direction of a first sensor; obtaining a second field of viewing direction of a second sensor, the second sensor being rotatable; obtaining time of the current moment; determining whether the second field of viewing direction is consistent with the first field of viewing direction; when the second field of viewing direction is different from the first field of viewing direction, calculating a synchronization time when the second sensor is rotated to change the second field of viewing direction to be consistent with the first field of viewing direction; determining whether the time of the current moment is earlier than the synchronization time by a preset time; when the time of the current moment is earlier than the synchronization time by a preset time, triggering the first sensor to output a first image; obtaining the first image; adjusting first sensing parameters of the first sensor to obtain second sensing parameters according to the first image; and when the second sensor is rotated to change the second field of viewing direction to be consistent with the first field of viewing direction, triggering the first sensor to output a second image based on the second sensing parameters.

A second aspect of the disclosure provides a multi-sensor synchronization system, the multi-sensor synchronization system comprises: at least one first sensor; at least one second sensor; and a main control device respectively connected to the first sensor and the second sensor, and the main control device comprises: a memory configured to store program instructions; and a processor configured to execute the program instructions to perform a multi-sensor synchronization method. The method comprises: obtaining a first field of viewing direction of a first sensor; obtaining a second field of viewing direction of a second sensor, the second sensor being rotatable; obtaining time of the current moment; determining whether the second field of viewing direction is consistent with the first field of viewing direction; when the second field of viewing direction is different from the first field of viewing direction, calculating a synchronization time when the second sensor is rotated to change the second field of viewing direction to be consistent with the first field of viewing direction; determining whether the time of the current moment is earlier than the synchronization time by a preset time; when the time of the current moment is earlier than the synchronization time by a preset time, triggering the first sensor to output a first image; obtaining the first image; adjusting first sensing parameters of the first sensor to obtain second sensing parameters according to the first image; and when the second sensor is rotated to change the second field of viewing direction to be consistent with the first field of viewing direction, triggering the first sensor to output a second image based on the second sensing parameters.

The multi-sensor synchronization method and the multi-sensor synchronization system, it is determined that whether the second sensor is synchronized with the first sensor according to whether the second field of viewing direction of the second sensor is consistent with the first field of viewing direction of the first sensor. When the second field of viewing direction is different from the first field of viewing direction, it indicates that the second sensor is not synchronized with the first sensor. Then the first sensor is triggered to output the first image, and the first sensing parameters of the first sensor are adjusted to obtain the second sensing parameters according to the first image. When the second field of viewing direction is consistent with the first field of viewing direction, it indicates that the second sensor is synchronized with the first sensor. Then the first sensor is triggered to output the second image based on the second sensing parameters. Sensing parameters of the first sensor are adjusted before the first sensor and the second sensor being synchronized. Then when the second sensor is synchronized with the first sensor, quality of the second image output by the first sensor is higher. So that synchronized data of the first sensor and the second sensor are more accurate, which can ensure driving safety of the autonomous driving vehicle.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a flow diagram of a multi-sensor synchronization method in accordance with an embodiment.

FIG. 2 illustrates a sub flow diagram of a multi-sensor synchronization method in accordance with the embodiment.

FIG. 3 illustrates a schematic diagram of an autonomous driving vehicle in accordance with the embodiment.

FIG. 4 illustrates a schematic diagram of viewing field of sensors in accordance with the embodiment.

FIG. 5 illustrates a first schematic diagram of field of viewing direction of sensors in accordance with the embodiment.

FIG. 6 illustrates a second schematic diagram of field of viewing direction of sensors in accordance with the embodiment.

FIG. 7 illustrates a schematic diagram of a main control device in accordance with the embodiment.

FIG. 8 illustrates a schematic diagram of a multi-sensor synchronization system in accordance with the embodiment.

### DETAILED DESCRIPTION OF THE EMBODIMENTS

In order to make purpose, technical solution and advantages of the disclosure more clearly, the disclosure is further described in detail in combination with drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by protection of the disclosure.

Terms “first”, “second”, “third”, “fourth”, if any, in specification, claims and drawings of this application are used to distinguish similar objects and need not be used to describe any particular order or sequence of priorities. It should be understood that data are interchangeable when appropriate, in other words, the embodiments described can be implemented in order other than what is illustrated or described here. In addition, terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that description refers to “first”, “second”, etc. in the disclosure are for descriptive purpose only and neither be construed or implied relative importance nor indicated as implying number of technical features. Thus, feature defined as “first” or “second” can explicitly or implicitly include one or more features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

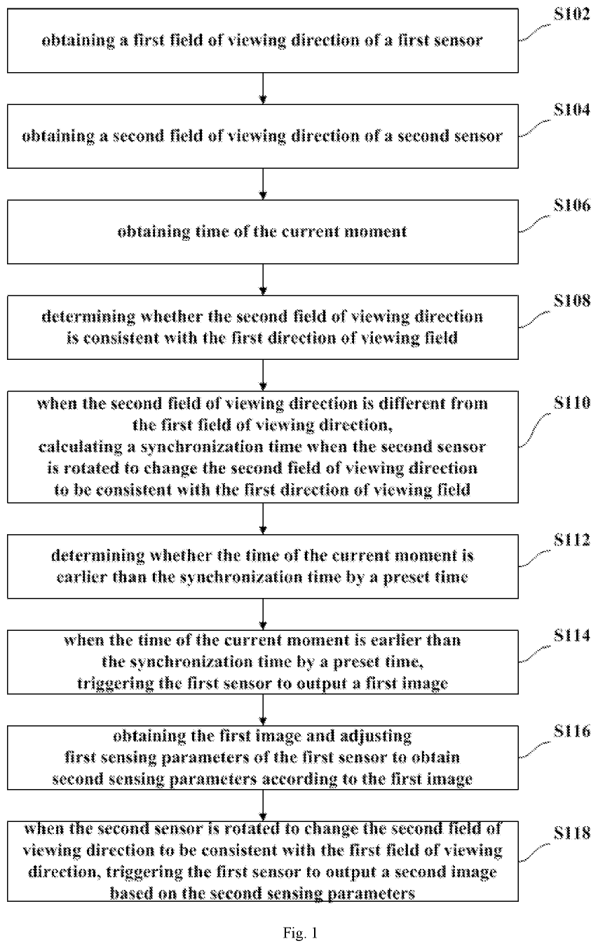

Referring to FIG. 1 and FIG. 3, FIG. 1 illustrates a flow diagram of a multi-sensor synchronization method in accordance with an embodiment, FIG. 3 illustrates a schematic diagram of an autonomous driving vehicle in accordance with the embodiment. The multi-sensor synchronization method includes but is not limited to applied to cars, motorcycles, trucks, sport utility vehicles, recreational vehicles, aircrafts and other transportation equipment. The transportation equipment is installed with a plurality of sensors, the multi-sensor synchronization method configured to control the sensors to be synchronized. So that the sensors can obtain environmental data accurately, which can ensure driving safety of the transportation equipment. Multi-sensor synchronization includes time synchronization and space synchronization.

In this embodiment, the multi-sensor synchronization method applied to an autonomous driving vehicle 100. The autonomous driving vehicle 100 has a level-four or a level-five autonomous driving system. The level-four autonomous driving system refers to “high automation”. Generally, a vehicle with the level-four autonomous driving system can perform its function without a human driver any longer. Even if the human driver dose not respond appropriately to an intervene request, the vehicle is capable of achieving the minimum risk state automatically. The level-five autonomous driving system refers to “full automation”. Generally, a vehicle with the level-five autonomous driving system can drive themselves on any legal and drivable road. The human driver only needs to set up the destination and turn on the level-five autonomous driving system, and the vehicle can be driven to the designated place through an optimized route. The multi-sensor synchronization method comprises the following steps.

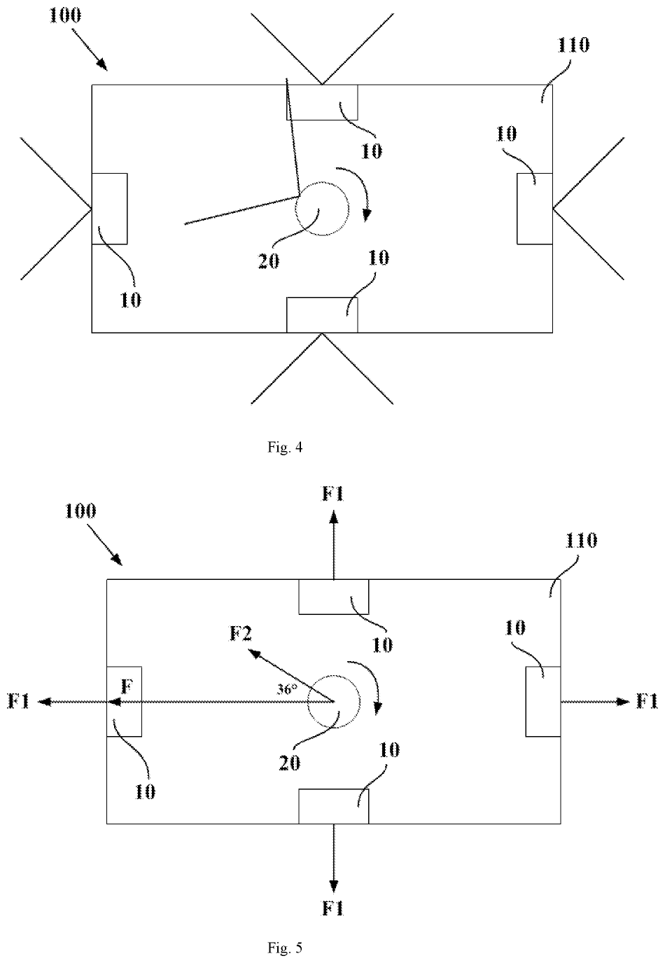

In step S102, a first field of viewing direction of a first sensor is obtained. This disclosure uses a main control device 30 installed in the autonomous driving vehicle 100 to obtain the first field of viewing direction F1 of the first sensor 10. In this embodiment, the autonomous driving vehicle 100 is equipped with a plurality of first sensors 10 (as shown in FIG. 4). The plurality of first sensors 10 are installed on the roof 110 of the autonomous driving vehicle 100 in a preset mode. For example, when the number of the first sensors 10 is four, the preset mode is that four first sensors 10 are respectively arranged in the middle of the side of the roof 110 close to the front 120, the middle of the side of the roof 110 close to the rear 130, and the middle of the left and right sides of the roof 110. The first sensor 10 installed in the middle of the side of the roof 110 close to the front 120 and the first sensor 10 installed in the middle of the side of the roof 110 close to the rear 130 are located on the same straight line. Two first sensors 10 installed in the middle of the left and right sides of the roof 110 are located on the same straight line. There is going to describe this embodiment in detail below by taking this as an example. In some embodiments, the plurality of first sensors may also be installed on the body 140 of the autonomous driving vehicle 100. In this embodiment, the first sensors are cameras, first field of viewing directions F1 are directions of central axis of the viewing field of the first sensors 10 (as shown in FIG. 5). It can be understood that the first field of viewing direction F1 of the first sensor 10 installed in the middle of the side of the roof 110 close to the front 120 faces directly front of the autonomous driving vehicle 100. The first field of viewing direction F1 of the first sensor 10 installed in the middle of the side of the roof 110 close to the rear 130 faces directly behind the autonomous driving vehicle 100. The first field of viewing direction F1 of the first sensor 10 installed in the middle of the left side of the roof 110 faces directly left of the autonomous driving vehicle 100. The first field of viewing direction F1 of the first sensor 10 installed in the middle of the right side of the roof 110 faces directly right of the autonomous driving vehicle 100. In this embodiment, the main control device 30 may obtain the first field of viewing directions F1 of the plurality of sensors 10 at the same time, the main control device 30 may also sequentially obtain the first field of viewing direction F1 of each first sensor 10 in a preset order. The preset order can be clockwise or counterclockwise, and can also be set according to actual situation.

In step S104, a second field of viewing direction of a second sensor is obtained. The second sensor is rotatable. This disclosure uses the main control device 30 to obtain the second field of viewing direction F2 of the second sensor 20. In this embodiment, the autonomous driving vehicle 100 is equipped with a second sensor 20 (as shown in FIG. 4). A second sensor 20 is installed in the middle of the roof 110 of the autonomous driving vehicle 100. In this embodiment, the second sensor 20 is a mechanical lidar, and the second sensor 20 is rotatable. Preferably, the second sensor 20 can be rotated 360 degrees. The second field of viewing direction F2 is direction of central axis of the viewing field of the second sensor 20 (as shown in FIG. 5). It can be understood that the when the second sensor 20 is rotated, the second field of viewing direction F2 also changes. The main control device 30 can sequentially obtain the first field of viewing direction F1 of each first sensor 10 according to rotation direction of the second sensor 20. For example, if the rotation direction of second sensor 20 is clockwise, when the second sensor 20 is rotated 36 degrees to the right towards the front of the autonomous driving vehicle 100, the main control device 30 obtain the first field of viewing direction F1 of the first sensor 10 installed on the right side of the roof 110.

In step S106, time of the current moment is obtained. In this embodiment, the main control device 30 can obtain the time of the current moment through a clock (not shown) installed on the autonomous driving vehicle 100, or through a wireless network, etc.

In step S108, it is determined that whether the second field of viewing direction is consistent with the first field of viewing direction. In this embodiment, the main control device 30 calculates a first angle between the first field of viewing direction F1 and a preset direction F according to the preset direction F and the first field of viewing direction F1. The main control device 30 calculates a second angle between the second field of viewing direction F2 and the preset direction F according to the preset direction F and the second field of viewing direction F2. Then the main control device 30 determines whether the first angle is the same as the second angle. The preset direction F is a preset standard direction. In this embodiment, the preset direction F is toward the front of the autonomous driving vehicle 100. Then, the first angle between the first field of viewing direction F1 and the preset direction F is 90 degrees, the second angle between the second field of viewing direction F2 and the preset direction F is 36 degrees, and the first angle is different from the second angle. Therefore, the second field of viewing direction F2 is different from the first field of viewing direction F1.

In step S110, when the second field of viewing direction is different from the first field of viewing direction, a synchronization time is calculated when the second sensor is rotated to change the second field of viewing direction to be consistent with the first field of viewing direction. In this embodiment, when the second field of viewing direction F2 is different from the first field of viewing direction F1, that is, when the second sensor 20 is not synchronized with the first sensor 10, this disclosure uses the main control device 30 to calculate difference between the first angle and the second angle. Then the main control device 30 calculates rotation time according to the difference and rotating speed of the second sensor 20. Time required for the second sensor 20 to rotate 360 degrees is 100 milliseconds. Then the rotating speed of the second sensor 20 is 3.6 degree/millisecond. The rotation time is time required for the second sensor 20 to rotate until the second field of viewing direction F2 is consistent with the first field of viewing direction F1. For example, if the first angle is 90 degrees and the second angle is 36 degrees, the difference between the first angle and the second angle is 54 degrees. The rotation time can be obtained by dividing the difference by the rotating speed. Then, the rotation time is 15 milliseconds. That is to say, after 15 milliseconds, the second field of viewing direction F2 will be consistent with the first field of viewing direction F1. Then the main control device 30 obtains the synchronization time according to the rotation time and the time of the current moment. It can be understood that the synchronization time represents the moment when the second sensor 20 is rotated to change the second field of viewing direction F2 to be consistent with the first field of viewing direction F1. For example, if the time of the current moment is 8:10:10.020 and the rotation time is 15 milliseconds, then the synchronization time is 8:10:10.035. That is to say, at 8:10:10.035, the second field of viewing direction F2 is consistent with the first field of viewing direction F1.

In step S112, it is determined that whether the time of the current moment is earlier than the synchronization time by a preset time. The preset time is any value between 9-25 milliseconds. In this embodiment, the preset time is 10 milliseconds. This disclosure uses the main control device 30 to determine whether the time of the current moment is 10 milliseconds earlier than the synchronization time. For example, the time of the current moment is 8:10:10.020 and the synchronization time is 8:10:10.035, the time of the current moment is 15 milliseconds earlier than the synchronization time, then the time of the current moment is 10 milliseconds earlier than the synchronization time. It can be understood that determine whether the time of the current moment is earlier than the synchronization time by the preset time is to determine whether the rotation time is greater than the preset time.

In step S114, when the time of the current moment is earlier than the synchronization time by a preset time, the first sensor is triggered to output a first image. In this embodiment, when the time of the current moment is earlier than the synchronization time, the main control device 30 triggers the first sensor 10 to output the first image, meanwhile the first sensor 10 has been capturing environmental data in real time. When the main control device 30 triggers the first sensor 10 to output the first image, the first sensor 10 outputs a frame of image.

In step S116, the first image is obtained, and first sensing parameters of the first sensor are adjusted to obtain second sensing parameters according to the first image. In this embodiment, this disclosure uses the main control device 30 to obtain the clarity of the first image and adjust the first sensing parameters to obtain the second sensing parameters according to the clarity of the first image. The first sensing parameters are sensing parameters currently set by the first sensor 10. The first sensing parameters include a first exposure parameter and a first white balance parameter. The second sensing parameters include a second exposure parameter and a second white balance parameter. The main control device 30 adjusts the first exposure parameter to obtain the second exposure parameter and adjusts the first white balance parameter to obtain the second white balance parameter according to the clarity of the first image. In some embodiments, the main control device 30 can obtain brightness of the first image and adjust the first sensing parameters to obtain the second parameters according to the brightness of the first image.

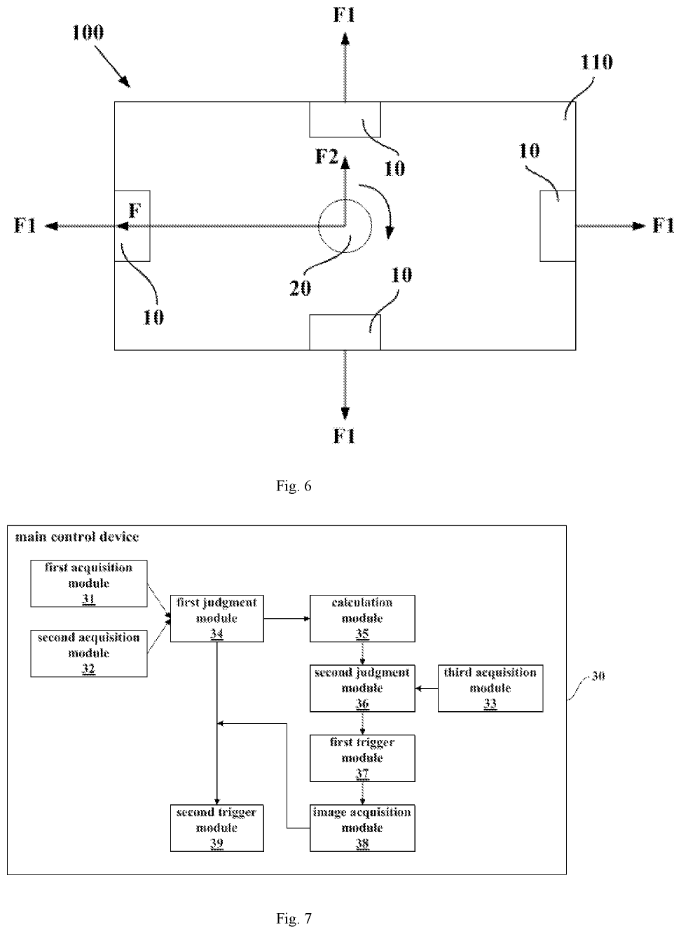

In step S118, when the second sensor is rotated to change the second field of viewing direction to be consistent with the first field of viewing direction, the first sensor is triggered to output a second image based on the second sensing parameters. In this embodiment, when the first angle is the same as the second angle, that is, when the second sensor 20 is rotated to change the second field of viewing direction F2 to be consistent with the first field of viewing direction F1 (as shown in FIG. 6), this disclosure uses the main control device 30 to trigger the first sensor 10 to output the second image based on the second sensing parameters. At this time, the second sensor 20 is synchronized with the first sensor 10. It can be understood that the second sensor 20 is synchronized with one of the plurality of the first sensors 10 every 100 milliseconds. Then the second field of viewing direction F2 is consistent with the first field of viewing direction F1 of one of the plurality of the first sensors 10 every 100 milliseconds. After the second field of viewing direction F2 is consistent with the first field of viewing direction F1, that is, after the first sensor 10 and the second sensor 20 are synchronized, the second field of viewing direction F2 will be consistent with the first field of viewing direction F1 again after 100 milliseconds. Due to the change of surrounding environment, the first exposure parameter and the first white balance parameter of the first sensor 10 do not match the environment after 100 milliseconds. As a result, an image output by the first sensor 10 based on the first sensing parameters may be unclear or too bright or too dark. Therefore, when the second sensor 20 has not been rotated to be synchronized with the first sensor 10, that is, before the second field of viewing direction F2 is consistent with the first field of viewing direction F1, the first sensing parameters are adjusted to the second sensing parameters according to the first image. Then when the second field of viewing direction F2 is consistent with the first field of viewing direction F1, that is, when the second sensor 20 is synchronized with the first sensor 10, clarity of the second image output by the first sensor 10 based on the second sensing parameters may be greater than a preset value. For example, the first sensing parameters are set based on a sunny environment with strong light. When the autonomous driving vehicle 100 drives into a tunnel environment with weak light, an image output by the first sensor 10 based on the first sensing parameters will unclear or too dark. The sensing parameters of the first sensor 10 are adjusted in advance to match the tunnel environment with weak light, so that quality of the image output by the first sensor 10 is higher.

In the above embodiment, it is determined that whether the second sensor is synchronized with the first sensor according to whether the second field of viewing direction of the second sensor is consistent with the first field of viewing direction of the first sensor. When the second field of viewing direction is different from the first field of viewing direction, it indicates that the second sensor is not synchronized with the first sensor. Then the first sensor is triggered to output the first image, and the first sensing parameters of the first sensor are adjusted to obtain the second sensing parameters according to the first image. When the second field of viewing direction is consistent with the first field of viewing direction, it indicates that the second sensor is synchronized with the first sensor. Then the first sensor is triggered to output the second image based on the second sensing parameters. Sensing parameters of the first sensor are adjusted before the first sensor and the second sensor being synchronized. Then when the second sensor is synchronized with the first sensor, both the first exposure parameter and the first white balance parameter of the first sensor are adapted to the surrounding environment, so that the second image output by the first sensor is clear, with appropriate brightness and higher quality. So that synchronized data of the first sensor and the second sensor are more accurate, which can ensure driving safety of the autonomous driving vehicle.

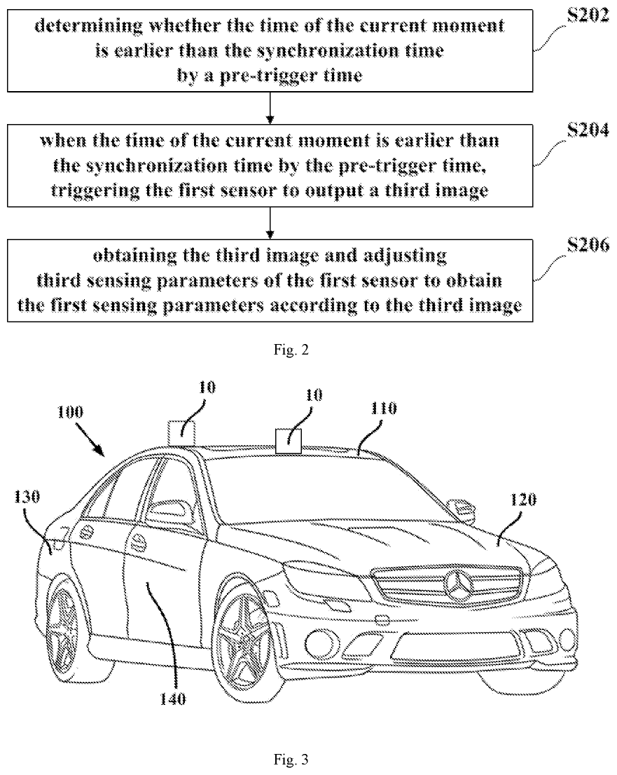

Referring to FIG. 2, FIG. 2 illustrates a sub flow diagram of a multi-sensor synchronization method in accordance with the embodiment. Before performing step S112, the multi-sensor synchronization method further includes the following steps.

In step S202, it is determined that whether the time of the current moment is earlier than the synchronization time by a pre-trigger time. The pre-trigger time is greater than the preset time. In this embodiment, the pre-trigger time is any value between 25-32 milliseconds. Preferably, the pre-trigger time is 32 milliseconds. This disclosure uses the main control device 30 to determine whether the time of the current moment is 32 milliseconds earlier than the synchronization time. It can be understood that determine whether the time of the current moment is earlier than the synchronization time by the pre-trigger time is to determine whether the rotation time is greater than the pre-trigger time.

In step S204, when the time of the current moment is earlier than the synchronization time by the pre-trigger time, the first sensor is triggered to output a third image. In this embodiment, when the current moment is earlier than the synchronization time by the pre-trigger time, the main control device 30 triggers the first sensor 10 to output the third image.

In step S206, the third image is obtained and third sensing parameters of the first sensor are adjusted to obtain the first sensing parameters according to the third image. In this embodiment, this disclosure uses the main control device 30 to obtain clarity of the third image and adjust the third sensing parameters to obtain the first sensing parameters according to the clarity of the third image. The third sensing parameters are sensing parameters currently set by the first sensor 10. The third sensing parameters include a third exposure parameter and a third white balance parameter. The main control device 30 adjusts the third exposure parameter to obtain the first exposure parameter and adjusts the third white balance parameter to obtain the first white balance parameter according to the clarity of the third image. So that the clarity of the third image is greater than the preset value. In some embodiments, the main control device 30 can obtain brightness of the third image and adjust the third sensing parameters to obtain the first sensing parameters according to the brightness of the third image.

In the above embodiment, the third sensing parameters are adjusted to the first sensing parameters according to the third image, and then the first sensing parameters are adjusted to the second sensing parameters according to the first image. Adjusting the sensing parameters based on more images can make the first sensor and the second sensor better synchronized, that is, the synchronized data is more accurate.

Referring to FIG. 7, FIG. 7 illustrates a schematic diagram of a main control device in accordance with the embodiment. The main control device 30 includes the following modules.

A first acquisition module 31 configured to obtain the first field of viewing direction F1 of the first sensor 10. This disclosure uses the first acquisition module 31 to obtain the first field of viewing direction F1 of the first sensor 10. The first acquisition module 31 may obtain the first field of viewing directions F1 of the plurality of sensors 10 at the same time, the main control device 30 may also sequentially obtain the first field of viewing direction F1 of each first sensor 10 in the preset order. The preset order can be clockwise or counterclockwise, and can also be set according to actual situation.

A second acquisition module 32 configured to obtain the second field of viewing direction F2 of the second sensor 20. The second sensor is rotatable. This disclosure uses the second acquisition module 32 to obtain the second field of viewing direction F2 of the second sensor 20. In this embodiment, the second acquisition module 32 can sequentially obtain the first field of viewing direction F1 of each first sensor 10 according to rotation direction of the second sensor 20.

A third acquisition module 33 configured to obtain the time of the current moment. In this embodiment, the third acquisition module 33 can obtain the time of the current moment through the clock (not shown) installed on the autonomous driving vehicle 100, or through a wireless network, etc.

A first judgment module 34 configured to determine whether the second field of viewing direction is consistent with the first field of viewing direction. In this embodiment, the first judgment module 34 calculates the first angle between the first field of viewing direction F1 and the preset direction F according to the preset direction F and the first field of viewing direction F1. The first judgment module 34 calculates the second angle between the second field of viewing direction F2 and the preset direction F according to the preset direction F and the second field of viewing direction F2. Then first judgment module 34 determines whether the first angle is the same as the second angle. The preset direction F is the preset standard direction.

A calculation module 35 configured to calculate the synchronization time when the second sensor 20 is rotated to change the second field of viewing direction F2 to be consistent with the first field of viewing direction F1 when the second field of viewing direction F2 is different from the first field of viewing direction F1. The second field of viewing direction F2 is different from the first field of viewing direction F1 indicates the second sensor 20 is not synchronized with the first sensor 10. In this embodiment, the calculation module 35 calculates difference between the first angle and the second angle. Then the calculation module 35 calculates rotation time according to the difference and rotating speed of the second sensor 20, that is, the rotation time can be obtained by dividing the difference by the rotating speed. Time required for the second sensor 20 to rotate 360 degrees is 100 milliseconds. Then the rotating speed of the second sensor 20 is 3.6 degree/millisecond. The rotation time is time required for the second sensor 20 to rotate until the second field of viewing direction F2 is consistent with the first field of viewing direction F1.

A second judgment module 36 configured to determine whether the time of the current moment is earlier than the synchronization time by the preset time. The preset time is any value between 9-25 milliseconds. In this embodiment, the preset time is 10 milliseconds. The second judgment module 36 determine whether the time of the current moment is 10 milliseconds earlier than the synchronization time.

A first trigger module 37 configured to trigger the first sensor 10 to output the first image when the time of the current moment is earlier than the synchronization time by the preset time. The first sensor 10 has been capturing environmental data in real time. When the first trigger module 37 triggers the first sensor 10 to output the first image, the first sensor 10 outputs a frame of image.

An image acquisition module 38 configured to obtain the first image, and adjust the first sensing parameters of the first sensor 10 to obtain second sensing parameters according to the first image. In this embodiment, the image acquisition module 38 obtain the clarity of the first image and adjust the first sensing parameters to obtain the second sensing parameters according to the clarity of the first image. The first sensing parameters are sensing parameters currently set by the first sensor 10. The first sensing parameters include the first exposure parameter and the first white balance parameter. The second sensing parameters include the second exposure parameter and the second white balance parameter. The image acquisition module 38 adjusts the first exposure parameter to obtain the second exposure parameter and adjusts the first white balance parameter to obtain the second white balance parameter according to the clarity of the first image. In some embodiments, the image acquisition module 38 can obtain brightness of the first image and adjust the first sensing parameters to obtain the second parameters according to the brightness of the first image.

A second trigger module 39 configured to trigger the first sensor 10 to output the second image based on the second sensing parameters when the second sensor 20 is rotated to change the second field of viewing direction F2 to be consistent with the first field of viewing direction F1. In this embodiment, when the first angle is the same as the second angle, that is, when the second sensor 20 is rotated to change the second field of viewing direction F2 to be consistent with the first field of viewing direction F1, the second trigger module 39 triggers the first sensor to output the second image based on the second sensing parameters. At this time, the second sensor 20 is synchronized with the first sensor 10. It can be understood that the second sensor 20 is synchronized with one of the plurality of the first sensors 10 every 100 milliseconds. Then the second field of viewing direction F2 is consistent with the first field of viewing direction F1 of one of the plurality of the first sensors 10 every 100 milliseconds. After the second field of viewing direction F2 is consistent with the first field of viewing direction F1, that is, after the first sensor 10 and the second sensor 20 are synchronized, the second field of viewing direction F2 will be consistent with the first field of viewing direction F1 again after 100 milliseconds. Due to the change of surrounding environment, the first exposure parameter and the first white balance parameter of the first sensor 10 do not match the environment after 100 milliseconds. As a result, the image output by the first sensor 10 based on the first sensing parameters may be unclear or too bright or too dark. Therefore, when the second sensor 20 has not been rotated to be synchronized with the first sensor 10, that is, before the second field of viewing direction F2 is consistent with the first field of viewing direction F1, the first sensing parameters are adjusted to the second sensing parameters according to the first image. Then when the second field of viewing direction F2 is consistent with the first field of viewing direction F1, that is, when the second sensor 20 is synchronized with the first sensor 10, clarity of the second image output by the first sensor 10 based on the second sensing parameters may be greater than the preset value. For example, the first sensing parameters are set based on a sunny environment with strong light. When the autonomous driving vehicle 100 drives into a tunnel environment with weak light, an image output by the first sensor 10 based on the first sensing parameters will unclear or too dark. The sensing parameters of the first sensor 10 are adjusted in advance to match the tunnel environment with weak light, so that quality of the image output by the first sensor 10 is higher.

In the above embodiment, the first trigger module and the second trigger module have a certain trigger frequency. If the trigger frequency is to trigger the first sensor 60 times within 100 milliseconds, then the first trigger module and the second trigger module trigger the first sensor every 16.66 milliseconds. That is to say, the first trigger module and the second trigger module can respectively trigger the first sensor to output one frame of image every 16.66 milliseconds. The first trigger module is configured to trigger the first sensor to output the first image and the second trigger module is configured to trigger the first sensor to output the second image. Then, when there is only one trigger module, and the trigger module triggers the first sensor to output the first image, the trigger module may be too late to trigger the first sensor to output the second image.

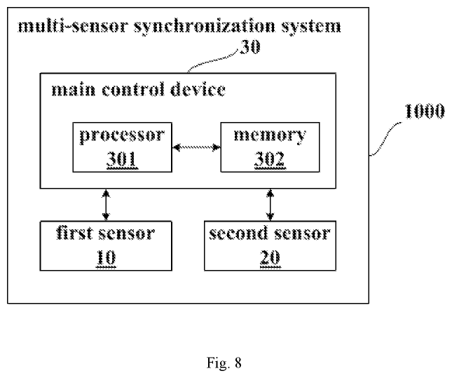

Referring to FIG. 8, FIG. 8 illustrates a schematic diagram of a multi-sensor synchronization system in accordance with the embodiment. The multi-sensor synchronization system 1000 includes at least one first sensor 10, at least one second sensor 20, and the main control device 30. The main control device 30 respectively connected to the first sensor 10 and the second sensor 20. In this embodiment, the main control device 30 includes a processor 301 and a memory 302. The memory 302 is configured to store program instructions. The processor 301 is configured to execute the program instructions to perform the multi-sensor synchronization method.

The processor 301, in some embodiments, may be a Central Processing Unit (CPU), controller, microcontroller, microprocessor, or other data processing chip used to run the program instructions stored in the memory 302.

The memory 302 includes at least one type of readable storage medium, which includes flash memory, hard disk, multimedia card, card-type memory (for example, SD or DX memory, etc.), magnetic memory, disk, optical disc, etc. Memory 302 in some embodiments may be an internal storage unit of a computer device, such as a hard disk of a computer device. Memory 302, in other embodiments, can also be a storage device for external computer devices, such as a plug-in hard disk, a Smart Media Card (SMC), a Secure Digital (SD) Card, a Flash Card, etc. equipped on a computer device. Further, the memory 302 may include both the internal and external storage units of a computer device. The memory 302 can not only be used to store the application software and all kinds of data installed in the computer equipment, such as the code to realize the multi-sensor synchronization method, but also can be used to temporarily store the data that has been output or will be output.

In the above embodiments, it may be achieved in whole or in part by software, hardware, firmware, or any combination thereof. When implemented in software, it can be implemented in whole or in part as a computer program product.

The computer program product includes one or more computer instructions. When the computer program instructions are loaded and executer on a computer, a process or function according to the embodiment of the disclosure is generated in whole or in part. The computer device may be a general-purpose computer, a dedicated computer, a computer network, or other programmable device. The computer instruction can be stored in a computer readable storage medium, or transmitted from one computer readable storage medium to another computer readable storage medium. For example, the computer instruction can be transmitted from a web site, computer, server, or data center to another web site, computer, server, or data center through the cable (such as a coaxial cable, optical fiber, digital subscriber line) or wireless (such as infrared, radio, microwave, etc.). The computer readable storage medium can be any available medium that a computer can store or a data storage device such as a serve or data center that contains one or more available media integrated. The available media can be magnetic (e.g., floppy Disk, hard Disk, tape), optical (e.g., DVD), or semiconductor (e.g., Solid State Disk), etc.

The technicians in this field can clearly understand the specific working process of the system, device and unit described above, for convenience and simplicity of description, can refer to the corresponding process in the embodiment of the method described above, and will not be repeated here.

In the several embodiments provided in this disclosure, it should be understood that the systems, devices and methods disclosed may be implemented in other ways. For example, the device embodiments described above is only a schematic. For example, the division of the units, just as a logical functional division, the actual implementation can have other divisions, such as multiple units or components can be combined with or can be integrated into another system, or some characteristics can be ignored, or does not perform. Another point, the coupling or direct coupling or communication connection shown or discussed may be through the indirect coupling or communication connection of some interface, device or unit, which may be electrical, mechanical or otherwise.

The unit described as a detached part may or may not be physically detached, the parts shown as unit may or may not be physically unit, that is, it may be located in one place, or it may be distributed across multiple network units. Some or all of the units can be selected according to actual demand to achieve the purpose of this embodiment scheme.

In addition, the functional units in each embodiment of this disclosure may be integrated in a single processing unit, or may exist separately, or two or more units may be integrated in a single unit. The integrated units mentioned above can be realized in the form of hardware or software functional units.

The integrated units, if implemented as software functional units and sold or used as independent product, can be stored in a computer readable storage medium. Based on this understanding, the technical solution of this disclosure in nature or the part contribute to existing technology or all or part of it can be manifested in the form of software product. The computer software product stored on a storage medium, including several instructions to make a computer equipment (may be a personal computer, server, or network device, etc.) to perform all or part of steps of each example embodiments of this disclosure. The storage medium mentioned before includes U disk, floating hard disk, ROM (Read-Only Memory), RAM (Random Access Memory), floppy disk or optical disc and other medium that can store program codes.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. A multi-sensor synchronization method, comprising:
obtaining a first field of viewing direction of a first sensor;
obtaining a second field of viewing direction of a second sensor, the second sensor being rotatable;
obtaining time of the current moment;
determining whether the second field of viewing direction is consistent with the first field of viewing direction;
when the second field of viewing direction is different from the first field of viewing direction, calculating a synchronization time when the second sensor is rotated to change the second field of viewing direction to be consistent with the first field of viewing direction;
determining whether the time of the current moment is earlier than the synchronization time by a preset time;
when the time of the current moment is earlier than the synchronization time by a preset time, triggering the first sensor to output a first image;
obtaining the first image;
adjusting first sensing parameters of the first sensor to obtain second sensing parameters according to the first image; and
when the second sensor is rotated to change the second field of viewing direction to be consistent with the first field of viewing direction, triggering the first sensor to output a second image based on the second sensing parameters.

2. The method as claimed in claim 1, wherein the first sensor is a camera, the second sensor is a mechanical lidar.

3. The method as claimed in claim 2, wherein adjusting first sensing parameters of the first sensor to obtain second sensing parameters according to the first image comprises:
obtaining clarity of the first image; and
adjusting the first sensing parameters to obtain the second sensing parameters according to the clarity of the first image.

4. The method as claimed in claim 3, wherein the first sensing parameters include a first exposure parameter and a first white balance parameter, the second sensing parameters include a second exposure parameter and a second white balance parameter, wherein adjusting the first sensing parameters to obtain the second sensing parameters according to the clarity of the first image comprises:
adjusting the first exposure parameter to obtain the second exposure parameter and adjusting the first white balance parameter to obtain the second white balance parameter according to the clarity of the first image, in order to make clarity of the second image is greater than a preset value.

5. The method as claimed in claim 2, wherein determining whether the second field of viewing direction is consistent with the first field of viewing direction comprises:
calculating a first angle between the first field of viewing direction and a preset direction according to the preset direction and the first field of viewing direction;
calculating a second angle between the second field of viewing direction and the preset direction according to the preset direction and the second field of viewing direction; and
determining whether the first angle is the same as the second angle.

6. The method as claimed in claim 5, wherein calculating a synchronization time when the second sensor is rotated to change the second field of viewing direction to be consistent with the first field of viewing direction comprises:
calculating difference between the first angle and the second angle;
calculating rotation time according to the difference and rotating speed of the second sensor; and
obtaining the synchronization time according to the rotation time and the time of the current moment.

7. The method as claimed in claim 2, further comprising:
determining whether the time of the current moment is earlier than the synchronization time by a pre-trigger time, the pre-trigger time being greater than the preset time;
when the time of the current moment is earlier than the synchronization time by the pre-trigger time, triggering the first sensor to output a third image;
obtaining the third image; and
adjusting third sensing parameters of the first sensor to obtain the first sensing parameters according to the third image.

8. The method as claimed in claim 7, wherein adjusting third sensing parameters of the first sensor to obtain the first sensing parameters according to the third image comprises:
obtaining clarity of the third image; and
adjusting the third sensing parameters to obtain the first sensing parameters according to the clarity of the third image.

9. A multi-sensor synchronization system, comprising:
at least one first sensor;
at least one second sensor; and
a main control device respectively connected to the first sensor and the second sensor, the main control device comprising:
a memory configured to store program instructions; and
a processor configured to execute the program instructions to perform a multi-sensor synchronization method, wherein the method comprising:
obtaining a first field of viewing direction of a first sensor;
obtaining a second field of viewing direction of a second sensor, the second sensor being rotatable;
obtaining time of the current moment;
determining whether the second field of viewing direction is consistent with the first field of viewing direction;
when the second field of viewing direction is different from the first field of viewing direction, calculating a synchronization time when the second sensor is rotated to change the second field of viewing direction to be consistent with the first field of viewing direction;
determining whether the time of the current moment is earlier than the synchronization time by a preset time;
when the time of the current moment is earlier than the synchronization time by a preset time, triggering the first sensor to output a first image;
obtaining the first image;
adjusting first sensing parameters of the first sensor to obtain second sensing parameters according to the first image; and
when the second sensor is rotated to change the second field of viewing direction to be consistent with the first field of viewing direction, triggering the first sensor to output a second image based on the second sensing parameters.

10. The system as claimed in claim 9, wherein the first sensor is a camera, the second sensor is a mechanical lidar.

11. The system as claimed in claim 10, wherein adjusting first sensing parameters of the first sensor to obtain second sensing parameters according to the first image comprises:
obtaining clarity of the first image; and
adjusting the first sensing parameters to obtain the second sensing parameters according to the clarity of the first image.

12. The system as claimed in claim 11, wherein the first sensing parameters include a first exposure parameter and a first white balance parameter, the second sensing parameters include a second exposure parameter and a second white balance parameter, wherein adjusting the first sensing parameters to obtain the second sensing parameters according to the clarity of the first image comprises:
adjusting the first exposure parameter to obtain the second exposure parameter and adjusting the first white balance parameter to obtain the second white balance parameter according to the clarity of the first image, in order to make clarity of the second image is greater than a preset value.

13. The system as claimed in claim 10, wherein determining whether the second field of viewing direction is consistent with the first field of viewing direction comprises:
calculating a first angle between the first field of viewing direction and a preset direction according to the preset direction and the first field of viewing direction;
calculating a second angle between the second field of viewing direction and the preset direction according to the preset direction and the second field of viewing direction; and
determining whether the first angle is the same as the second angle.

14. The system as claimed in claim 13, wherein calculating a synchronization time when the second sensor is rotated to change the second field of viewing direction to be consistent with the first field of viewing direction comprises:
calculating difference between the first angle and the second angle;
calculating rotation time according to the difference and rotating speed of the second sensor; and
obtaining the synchronization time according to the rotation time and the time of the current moment.

15. The system as claimed in claim 10, further comprising:
determining whether the time of the current moment is earlier than the synchronization time by a pre-trigger time, the pre-trigger time being greater than the preset time;
when the time of the current moment is earlier than the synchronization time by the pre-trigger time, triggering the first sensor to output a third image;
obtaining the third image; and
adjusting third sensing parameters of the first sensor to obtain the first sensing parameters according to the third image.

16. The system as claimed in claim 15, wherein adjusting third sensing parameters of the first sensor to obtain the first sensing parameters according to the third image comprises:
obtaining clarity of the third image; and
adjusting the third sensing parameters to obtain the first sensing parameters according to the clarity of the third image.
